(19) United States
(12) Patent Application Publication
(10) Pub. No.: US 2016/0304200 A1
(43) Pub. Date: Oct. 20, 2016

(54) FUMIGATION DEVICE

(71) Applicant: Jorge Alejandro LOPEZ-POY, CABA (AR)

(72) Inventor: Jorge Alejandro LOPEZ-POY, CABA (AR)

(21) Appl. No.: 14/686,532

(22) Filed: Apr. 14, 2015

(51) Int. Cl. B64C 39/02; A01M 13/00; B64D 27/02; B64C 27/08; B64D 27/24

(52) U.S. Cl. CPC B64C 39/024; B64C 27/08; B64D 27/24; B64D 27/02; A01M 13/00; B64C 2201/12; B64C 2201/108; B64C 2201/042; B64C 2201/04; B64D 2027/026

(57) ABSTRACT

A fumigation device suitable for agricultural purposes, using aerodynamic hovering without touching the ground, which operates autonomously or under the supervision of a remote operator, comprising at least four rotors individually operated through energy generating devices, with a constant rotor speed, being the only control variable for the whole flight steering. Since the device only operates in ground effect, it is fair to say that it is not exactly an airplane; in addition, it does not carry crew, and it only operates within rural areas as other agricultural machines, being able to be transported on a trailer; therefore, it would operate outside the rule of aeronautic regulations. It has full redundancy of systems both for thrust and control. Any of the components can stop functioning or start to function erratically, avoiding life loss, since it simply activates an alarm and makes the aircraft stop with the rest of the available redundant systems, without entailing a loss of the steering command, not even momentarily.

### FIELD OF THE INVENTION

The present invention relates to a fumigation device of the kind employed for agricultural purposes using aerodynamic hovering without touching the ground.

### BACKGROUND OF THE INVENTION

Nowadays there are different types of fumigation devices for the application of agrochemicals, for which there are two main classifications: soil fumigation and aerial fumigation. The first has the benefit of being simpler to operate, since it does not entail a pilot or strict maintenance or aeronautical regulations. Conversely, aerial fumigators have the huge benefit of being operated without touching the ground or the crops, which makes it possible to fumigate regardless of the condition of the soil, even if it is waterlogged, and they do not harm plants in any stage of their development. In practice, these benefits make a difference in the operating cost between the two methods, of about two to one. On the other hand, many of the tasks of operators, pilots and engine drivers have been automated with GPS and autopilot systems, and in the case of soil fumigators, these have even been completely robotized, making engine drivers unnecessary.

Aerial fumigators are mostly fixed-wing aircrafts—airplanes—that require runways to take off and land, and only in few cases are modified helicopters used for fumigating purposes. Although the latter do not require runways, they are more expensive to operate due to the complexity of their design.

Nowadays there are also micro multi-rotor rotorcrafts, which are electrically operated and fly autonomously. These aerial robots have a microprocessor that controls the flight, making the fixed-pitch rotors the only mobile parts in the aircraft. All the functions such as flight control, pitch, roll, yaw, climb, descent and thrust or stop any direction are achieved by just varying the revolutions of the different rotors. The minimum number of rotors needed to achieve full control is four, with the possibility of being more by adding them in pairs. No pilot can be trained to handle this configuration directly by controlling the speed of the rotors. The only way to solve this control problem is to use a microprocessor and acceleration and yaw sensors. Since there are control networks constantly correcting the speed of the rotors many times every second, these sensors maintain stability and control, enabling the aircraft to be operated manually, either following directions or completely autonomously according to a flight plan. All this is easily achievable thanks to the quick response of the electronic circuits and the instantaneous electric drive of the engines. The main limitation of these micro aircrafts is their small size and the flight autonomy. Since they are operated electrically, they require batteries that undermine their capacity and size, making them useful only for aerial photography purposes.

For example, micro drones, manufactured and distributed by Microdrones GmbH, stand out. These devices were designed for field recognition, filming accidents, cartography and monitoring purposes. However, none of the uses offered by that company suggests the possibility of undertaking other tasks such as fumigation.

On the other hand, the autonomy of these devices is limited, since they only make use of conventional batteries for energy supply, both for movement and for the previously mentioned applications.

### SUMMARY OF THE INVENTION

An object of this invention is to provide a fumigation device of the kind employed for agricultural purposes using aerodynamic hovering without touching the ground, which operates autonomously or under the supervision of a remote operator and at ground effect.

An object of the present invention is therefore to provide a fumigation device of the kind employed for agricultural purposes using aerodynamic hovering without touching the ground, which operates autonomously or under the supervision of a remote operator, and which has at least four rotors triggered individually through power generators, in which the variation of the rotors revolutions has a fixed pitch, being the only control variable for the aircraft's operation.

An object of this invention is to provide a fumigation device that should no be considered as an aircraft. Thus, the present device does not need to meet the Federal Aviation Administration regulations or any other regulation worldwide.

### BRIEF DESCRIPTION OF THE DRAWINGS

In order to understand the object of the present invention more clearly, it has been illustrated in several figures, represented in one of the preferred forms of realization. The following examples show:

FIG. 1: rotors design outline and their direction of rotation.

FIG. 2: top view of the device, object of the present invention.

FIG. 3: elevated front view of the device shown in FIG. 2.

FIG. 4: side view of the device, object of the present invention.

FIG. 5: diagram of the electrical energy management and the general control system of the device of FIG. 2, and

FIG. 6: diagram of the hydraulic energy management and the general control system of the device in FIG. 2.

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

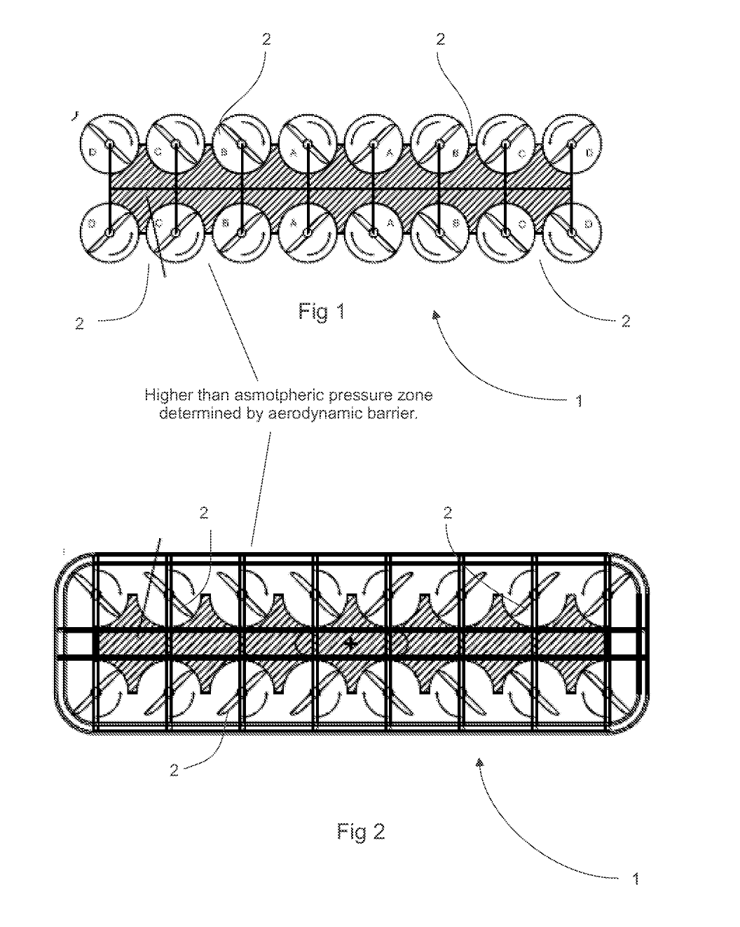

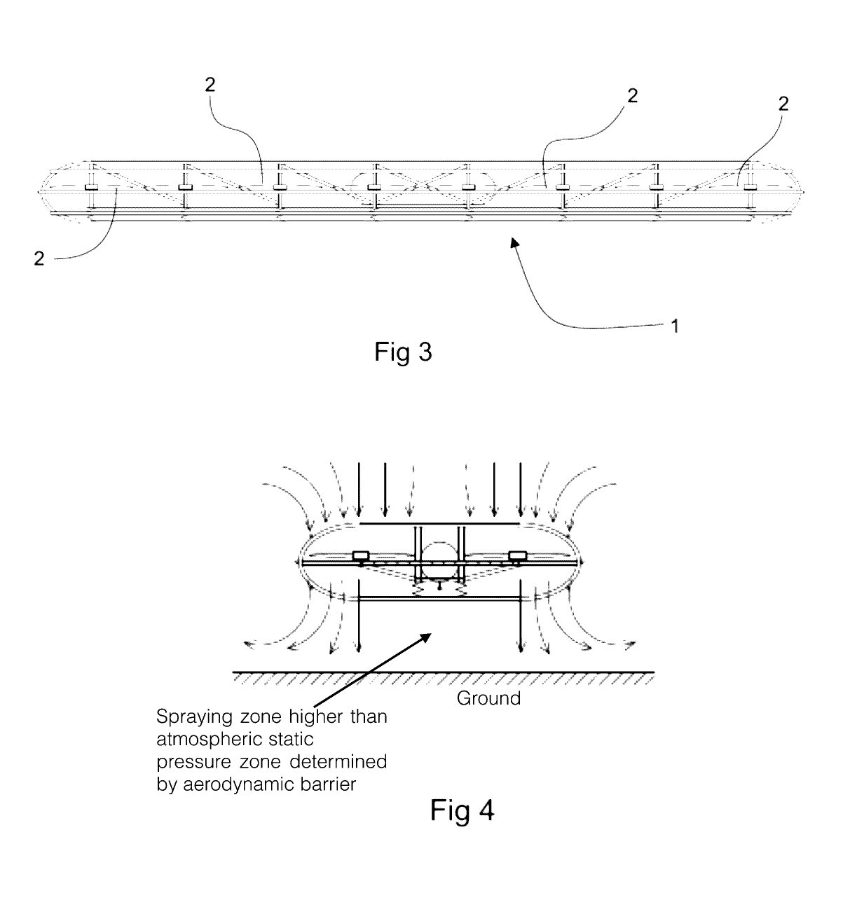

In FIGS. 1 to 4, it is possible to appreciate the device depicted under the general reference number 1. The diagram shows that the device operates as four concentric quadcopters, the first being A, the second B, the third C, and finally the external and fourth D. This configuration is valid for any number of rotors that is a multiple of four. In the example presented here the number is 16, but it could as well be 8, 12, 16, 20, etc. The more rotors, the greater redundancy will be. It is worth mentioning that one of the objects of the present invention and the main difference with previous art is the redundancy of the systems. In the case of a device with twelve rotors, these function as three independent concentric systems with four rotors, and in the case of devices with sixteen rotors, these would function as four independent concentric systems, which enables the device to continue operating in case one of the rotors or systems of control fails or is impaired, since there is full redundancy.

The aerodynamic hovering is achieved with rotors 2, triggered individually through electric brushless motors, which generate a thrust as a reaction to propelled air. In order to fully steer the flight without any other control variable than the speed of rotors, you need at least four rotors, being multiples of four the ideal numbers, since they enable the system to be fully redundant, preferably twelve and sixteen. These motors 2 are fed through power transistors that are controlled by a microprocessor every four rotors, ensuring stability and navigation. The control and navigation are similar to the existing micro aircrafts. However, there are substantial differences between them.

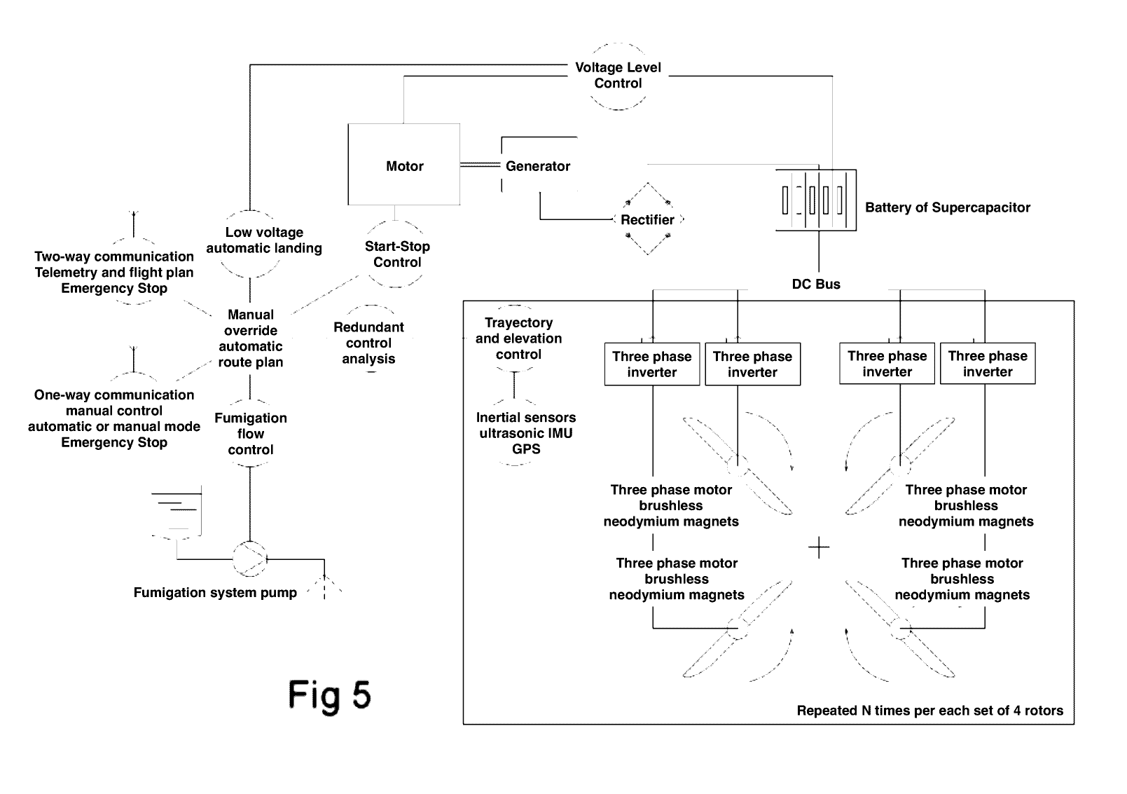

The first difference is the electric power supply. This fumigator is a hybrid system in which the battery is replaced by one or several generators, thus achieving more operational autonomy. The generator can be triggered by piston engines o preferably by a micro gas turbine, as shown in the diagram of FIG. 5.

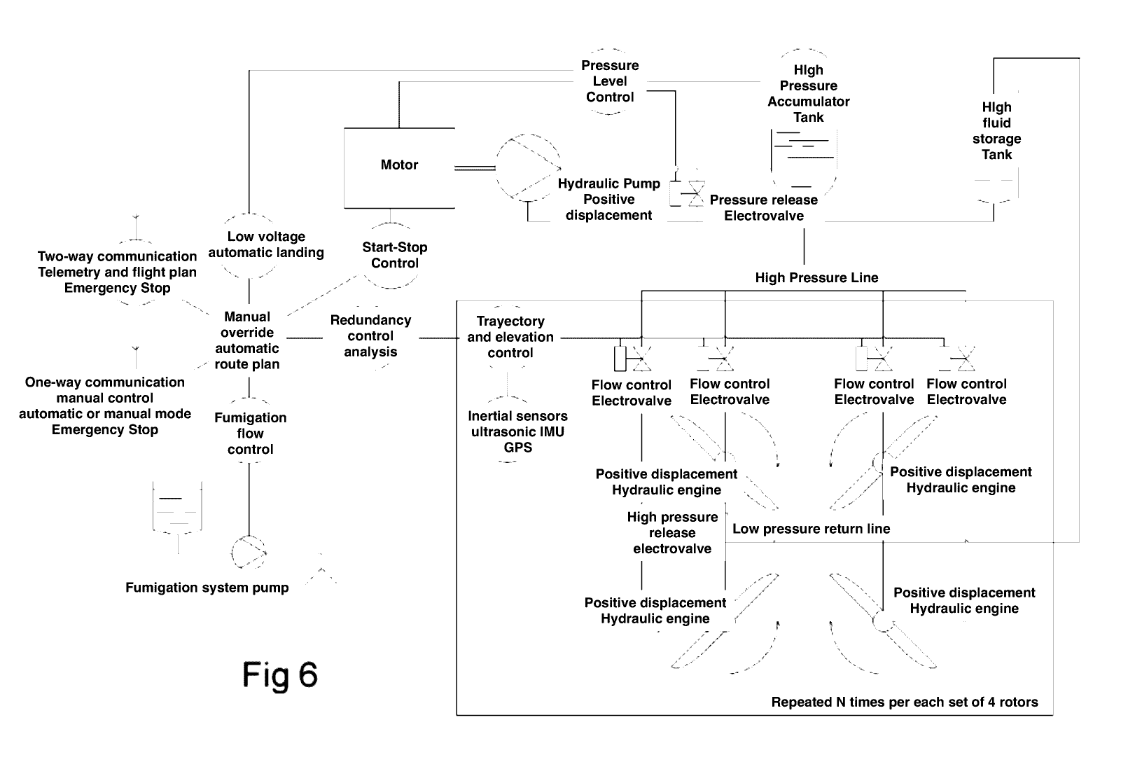

As a realization alternative it is possible to observe the hydraulic version in FIG. 6. In this hydraulic version, also electronically controlled, the generator is replaced by a pump whose function is to maintain a constant hydraulic pressure regardless of the demand. This is achieved by varying the flow with the revolutions of the piston engine or using a variable displacement pump plugged to the turbine reducer. In this case, the rotor speed can be controlled with hydraulic proportional flow valves operated in proportional electric pulses, modulation of the pulse width, steered by the same microprocessor as in the electrical variant.

In addition, there is an important difference with small micro aircrafts, and it lies in the redundancy of the systems. In the case of the twelve rotors, these function as three independent concentric systems of four rotors, which enable the device to continue operating in case one of the rotors or systems of control fails or is impaired, since there is full redundancy. Another feature of the present invention is that it has a bank of lithium batteries or a capacitor bank, which enables it to operate during a certain period of time without generators, and in the case of the hydraulic version, the batteries are replaced by an accumulator of hydraulic pressure: a recipient constructed with a carbon filament winding (used to eliminate weight in front of steel accumulators) with an elastomeric bladder used to contain gas as a lung, making it possible to maintain pressure in the line for a few seconds in the case of an engine shutdown; in both cases, this enables the system to be stopped gently in case of an outage in the energy supply of the motor or turbine.

In the electrical realization described in FIG. 5, we see the direct current energy bank right after the rectifiers of the alternators generators and it is the source of the power transistors that work as investors to trigger the brushless motors. All of the auxiliary systems are electrical and, together with the fumigating pumps and the lighting valves, they are supplied by this direct current source; only microprocessors (because their energy consumption is minimal) and the wireless communication system have their own autonomous power sources with small lithium batteries which are permanently charging themselves with regulators that take energy from this same bank.

It is important to mention that the wireless communication system has a serial data transmission similar to Wi-Fi systems, but with broader scope. This is a double system that operates in two frequencies: 450 MHz, 900 MHz, 1.8 Ghz, 2.4 Ghz or 5 GHz. Through one of the frequencies, communication is bidirectional, guaranteeing the telemetry, control and programming of the navigation plan, as well as the possibility of having an operator perform an emergency stop. Through the other frequency, transmission is only unidirectional towards the fumigator, enabling manual control and the possibility to alternate between manual and automatic modes, in addition to the emergency stop which is redundant. In the case of loss of communication, the emergency stop is triggered automatically.

In addition, the control system is programmed to operate always at a very short distance from the ground, only a few inches above the crops. To keep this distance, it relies on sensors, which can work via ultrasound or preferably through laser scanners. Floating with ground effect reduces the necessary energy for sustentation and improves the effectiveness of the fumigation. On the other hand, this particular feature allows this device, object of the present invention, to find itself outside the rule of aeronautic regulations, since it is not an airplane. Finally, and thanks to the microprocessor-controlled system, there are horizontal distance measuring sensors, similar to the vertical measuring sensors, which are used to detect any object that may come across the flight path; as the distance to the object diminishes, so does the speed. This function of the microprocessor has authority even in manual mode, allowing it to get infinitesimally close at an infinitesimal speed until it stops at a minimum distance from the object. In automatic mode, it completely stops, landing after some seconds if the obstacle does not move.

It is important to remark that the device has full redundancy systems both for thrust and control. Each of the components can stop functioning of function erratically, and avoid a loss of life, since it only triggers an alarm and produces a slow automatic stop with the rest of the redundant available systems, without entailing a loss of steering-control, not even transitorily. Furthermore, the device of the present invention has an aerodynamic barrier in the central area of the rotors to stop the recirculation of the air upward. This allows the generation of a higher than atmospheric static pressure zone, increasing sustentation force with better energy efficiency improving spraying application inside this zone.

Since it only operates on ground effect, we can say that this is not exactly an airplane; in addition, it does not carry crew, and it only operates within rural areas, as the rest of agricultural machines, which enables it to be moved from one place to another on a trailer, therefore operating outside aviation regulations.

Although the present invention has been described herein with reference to the foregoing exemplary embodiment, this embodiment does not serve to limit the scope of the present invention. Accordingly, those skilled in the art to which the present invention pertains will appreciate that various modifications are possible, without departing from the technical spirit of the present invention.

I claim:

1. A fumigation device suitable for agricultural purposes using aerodynamic hovering without touching the ground, in which the device functions autonomously or under supervision of a remote operator, said fumigation device comprises: at least four rotors individually started through energy generators, in which the variation of revolutions of the rotors are set at a fixed pitch, being the only control variable for the whole steering.

2. The device as recited in claim 1, wherein said energy generators are defined by a hybrid energy management system, in which there is an electric energy generating system based on fuel consumption, and a system of electrical energy use, comprised by electrical power controllers.

3. The device as recited in claim 1, wherein said rotors are individually operated by electrical engines.

4. The device as recited in claim 1, wherein said rotors are operated by hydraulic engines.

5. The device as recited in claim 4, wherein said hydraulic motors present a hybrid energy management system comprising an hydraulic energy-generating system based on fuel consumption including a piston engine which operates a hydraulic bomb and a system of hydraulic energy use, which is comprised by hydraulic proportional valves for flow control used to operate the hydraulic engines of said rotors.

6. The device as recited in claim 1, further comprising means of electrical energy accumulation including: a set of lithium batteries, a set of super capacitors or a combination thereof, defining means of auto-control during a brief stop lapse.

7. The device as recited in claim 1, further comprising means of hydraulic energy accumulation in the form of a volume subjected to high pressure, in a hydraulic lung of ultra light composite material, with compressed gas in an elastic bladder, defining auto-control during a brief stop lapse.

8. The device as recited in claim 1, further comprising a protective chassis made out of lattice and nets.

9. The device as recited in claim 1, further comprising a double means of data communication with different frequencies.

10. The device as recited in claim 9, wherein said double means of data communication comprises a first bidirectional means of data communication for telemetry, route plans and emergency stop, and a second unidirectional means of communication to switch from manual to automatic mode and manual control, and a redundant emergency stop.

11. The device as recited in claim 1, further comprising a height-operating limit, defined by distance sensors, configured to operate said fumigation device below regulated aerial space.

12. The device as recited in claim 11, further comprising means of horizontal distance sensors that defines a stop during the trajectory in case of obstacles being detected.

13. The device as recited in claim 1, comprising a total redundancy of systems, both for thrust and control, which, in the case any of the components stops functioning or starts malfunctioning, an alarm is activated and a slow automatic stop is carried out using the rest of the available redundant systems, without affecting the control of the device.

14. The device as recited in claim 1, wherein the device has an aerodynamic barrier in the central area of the rotors to stop the upward recirculation of air.

15. The device as recited in claim 4, further comprising auxiliary systems of fumigation bombs and valves.

16. The device as recited in claim 11, wherein said distance sensors comprise at least one of: an ultrasonic sensor and a laser sensor.

17. The device as recited in claim 12, wherein said means of horizontal distance sensors comprises at least one of: an ultrasonic sensor and a 360-degree laser scanner.
